(19) United States
(12) Patent Application Publication
(10) Pub. No.: US 2019/0071217 A1
(43) Pub. Date: Mar. 7, 2019

(54) CUP CAKE TRAY

(71) Applicant: Pinnpack Packaging, LLC, Oxnard, CA (US)

(72) Inventors: Dean Brown, Oxnard, CA (US); Ira Maroofian, Oxanard, CA (US)

(73) Assignee: Pinnpack Packaging, LLC, Oxnard, CA (US)

(21) Appl. No.: 15/693,795

(22) Filed: Sep. 1, 2017

(51) Int. Cl. B65D 25/10; A47J 47/08; B65D 1/36; B65D 43/16; B65D 43/22; B65D 85/36

(52) U.S. Cl. CPC B65D 25/10; A47J 47/08; B65D 85/36; B65D 43/163; B65D 43/22; B65D 1/36

(57) ABSTRACT

The invention is directed toward a cup cake tray that has a number of nubs or retainers having an engagement portion around the edges of the cup cake cavity that extend into a cup cake cavity to prevent the cup cake from falling out of the cup cake cavity if the cup cake tray is jarred or inverted. The engagement features engage the edge of the cup cake to keep it within the cup cake cavity. In some embodiments, the cup cake tray further includes cutouts or grooves proximate the cup cake cavity that allow a person to insert their fingers into the cutouts and remove the cup cakes from the cup cake cavity without damaging them

### FIELD

The present invention relates to a cup cake tray and, more particularly, to a cup cake tray that retains the cup cakes in a desired position and prevents them from popping out or falling out of the tray when jarred or inverted.

### BACKGROUND

Cup cake trays are designed to safely transported the cup cakes without damage. Typical cup cake trays usually include a base having cavities or recesses to hold the cup cakes and cover that are connected together. The cavities or recesses only prevent side-to-side movement in the cup cake tray, not up and down motion. So if the cup cake tray is jarred or inverted, the cup cakes can move up and out of the cavities or recesses and may get damaged.

It would be desirable to have a cup cake tray that can safely transport cup cakes without damage, even in the event they are inverted. It is with this need in mind that the present invention was developed.

### SUMMARY OF THE INVENTION

Embodiments described herein may meet one or more of the needs identified above and may overcome one or more of the shortcomings of current blepharitis treatment methods. Various implementations of systems, methods, and devices within the scope of the appended claims each have several aspects, no single one of which is solely responsible for the desirable attributes described herein. Without limiting the scope of the appended claims, some prominent features are described herein.

The present application relates generally to a cup cake tray having one or more cavities with cup cake retainers configured to hold the cup cakes within the cup cake cavity.

One aspect of this disclosure provides a cup cake tray comprising a tray base having one or more cup cake cavities configured to receive a cup cake, one or more retainers coupled to the tray base proximate each cavity opening, each retainer having a portion extending inwardly into the cup cake cavity forming cup cake engagement portions, herein, the cup cake engagement portions are configured to engage a top edge of the cup cake and hold the cup cake in the cavity, thereby preventing inadvertent cup cake movement out of the cavity.

A further aspect of the disclosure provides a cup cake tray comprising a tray base having one or more cup cake cavities configured to receive a cup cake and one or more retainers proximate each cavity opening, each retainer having a portion extending inwardly into the cup cake cavity forming cup cake engagement portions and a tray top coupled to the tray base configured to cover the cup cakes without touching the cup cake or any cup cake icing. Wherein, the cup cake engagement portions are configured to engage a top edge of a cup cake and hold the cup cake in the cavity, thereby preventing inadvertent cup cake movement out of the cavity;

In some embodiments, the retainers are integral with the tray base. In some embodiments, the retainers are attached to the tray base in a secondary operation. In some embodiments, the tray base, retainers and or top are formed by injection molding, blow molding, thermoforming or vacuum molding techniques. In some embodiments, the tray base, retainers and or top are made from polystyrene or polyethylene, rubber, or any suitable material. In some embodiments, the cup cake tray further comprises finger slots formed in the tray base on opposite sides of the cavities, wherein the finger slots are sized and shaped for insertion of a pair of fingers on opposite sides of a cavity to engage and compress the cup cake to disengage the cup cake from the cup cake engagement portion for removal of the cup cake from the cavity.

An additional aspect of the disclosure provides a method of using any one of the cup cake trays described herein, the method comprising inserting one or more cup cakes into the one or more cup cake cavities and engaging a top of the cup cake with the cup cake engagement portions, thereby preventing inadvertent cup cake movement out of the cavity. To remove the cup cake, the method includes inserting fingers into slots or grooves proximate the cavities to engage the cup cake, compressing the cup cake to disengage the cup cake from the engagement portions, and removing the cup cake from the cavity.

There has thus been outlined, rather broadly, the more important features of the invention in order that the detailed description thereof may be better understood, and in order that the present contribution to the art may be better appreciated. There are additional features of the invention that will be described hereinafter and which will form the subject matter of the claims appended hereto. The features listed herein and other features, aspects and advantages of the present invention will become better understood with reference to the following description and appended claims.

### BRIEF DESCRIPTION OF THE DRAWINGS

The present embodiments may be understood from the following detailed description when read in conjunction with the accompanying figures. It is emphasized that the various features of the figures are not necessarily to scale. On the contrary, the dimensions of the various features may be arbitrarily expanded or reduced for clarity.

FIG. 1 is a perspective view showing one embodiment of a cup cake tray having cup cake retaining features;

FIG. 2 is a cross-sectional view showing one embodiment of a cup cake tray cavity or recess engagement with a cup cake; and

FIG. 3 is a perspective view showing one embodiment of the cup cake base of FIG. 1 having with a top.

### DETAILED DESCRIPTION

Embodiments of the invention will now be described with reference to the figures, wherein like numerals reflect like elements throughout. The terminology used in the description presented herein is not intended to be interpreted in any limited or restrictive way, simply because it is being utilized in conjunction with detailed description of certain specific embodiments of the invention. Furthermore, embodiments of the invention may include several novel features, no single one of which is solely responsible for its desirable attributes or which is essential to practicing the invention described herein.

Broadly, an embodiment of the present invention provides a cup cake tray that has a number of nubs or retainers around the edges of the cup cake cavity having an engagement portion that extend into a cup cake cavity to prevent the cup cake from falling out of the cup cake cavity if the cup cake tray is jarred or inverted. The engagement features engage the edge of the cup cake to keep it within the cup cake cavity. In some embodiments, the cup cake tray further includes cutouts or grooves proximate the cup cake cavity that allow a person to insert their fingers into the cutouts and remove the cup cakes from the cup cake cavity without damaging them.

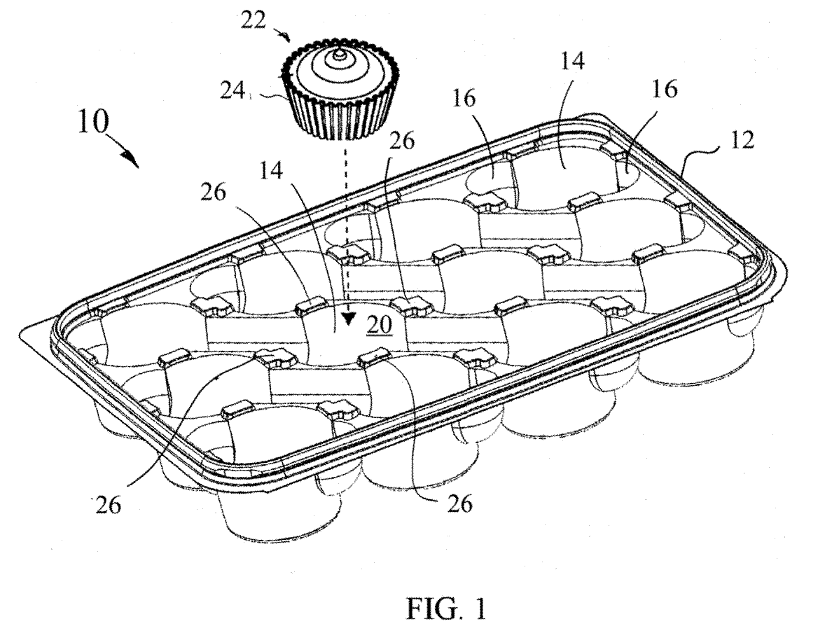

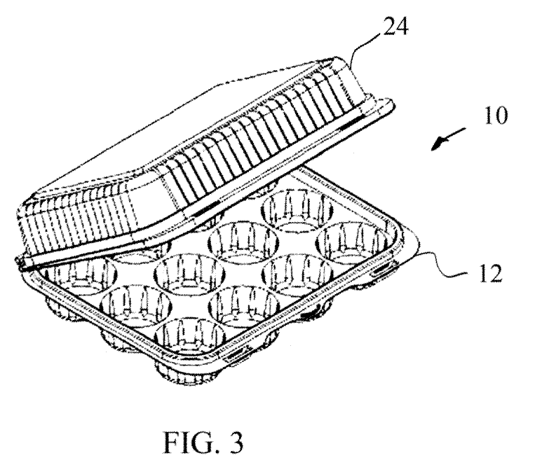

FIG. 1 shows one embodiment of a cup cake tray 10 having a base 12 with one or more cup cake cavities 14 used for storing and transporting cup cakes. The base 12 may be designed with more or less cavities than shown in the figures. The cup cake tray 10 may be used with or without a lid or top. In some embodiments, the cup cake tray 10 may be used as a serving tray. In some embodiments, the base may have raised edges and the cake tray may be covered with a film (sealed or wrapped) that does not touch the cup cake or its icing. In some embodiments, the top may be a separate part. In some embodiments, the top may integral with the base. FIG. 3 shows one embodiment of a top that is integral with the base having an integral hinge, such as a flexible or living hinge. The top may also include locking feature with the base.

The base 12 further includes finger slots or grooves 16 proximate the cavities 14. The finger slots 16 are shaped to allow a person to insert their fingers into the finger slots 16 remove the cup cake from the tray. In the embodiment shown, the finger slots 16 are two finger slots 16 disposed on opposite sides of the cup cake cavity 14. In other embodiments, there may be more or less finger slots.

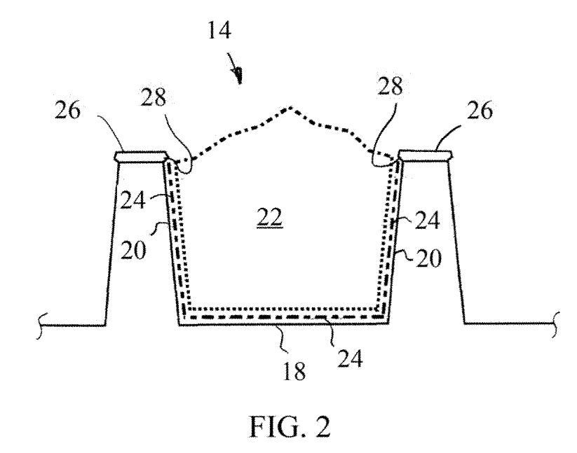

FIG. 2 shows one embodiment of a cup cake cavity 14 for holding a cup cake, generally denoted by the numeral 22. The cavity 14 is typically round and sized to generally match the diameter of the cup cake. The cavity 14 includes a bottom 18, sides 20 extending upwardly from bottom 18.

Around a perimeter of the cup cake cavity 14 opening are numerous nubs or retainers 26 having engagement portions 28 designed to prevent a cup cake 22 from unintentionally popping out of the cavity 14, even if the cup cake tray 10 is tipped on its side or turned upside down. The engagement portions 28 of the retainers 26 extend into the cup cake cavity 14 a sufficient distance and engage the cup cake 22 or a cup cake liner or sleeve 24, so that the cup cake 22 is held within the cavity 14. The figure shows the nubs or retainers 26 positioned on opposite sides of the cup cake cavity 14, but they can be positioned at any point around the circumference of the cavity.

To remove the cup cake 22 from the cavity 14, a person inserts their fingers in the slots or grooves 16, proximate the nubs or retainers 26, and compresses the cup cake 22 slightly inward to disengage the cup cake 22 or sleeve 24 from the engagement portions 28. The cup cake 22 can them be removed upwardly from the cavity 14.

The nubs or retainers 26 may be formed integrally with the base 12 or added to the base in a secondary operation, such as with adhesive. The engagement portions 28 are shown with an angled engagement surface. Other shapes for the retention portions 28, however, are contemplated within the scope of the present invention.

The various embodiments of the base 12 and retainers 26 may be manufactured of any type of suitable plastic such as polystyrene or polyethylene, rubber, or any other suitable material. These materials may be opaque, clear or translucent, and the material of construction may be colored by pigments or any type of dye. The manufacturing techniques for making the cup cake holders may be any conventional method, including injection molding, blow molding, thermoforming or vacuum molding techniques. In some embodiments that base may also include pleats.

FIG. 3 shows one embodiment of the tray 10 having a base 12 and top 30 with a living or integral hinge 32 securing the base and top together along one edge. The top may be formed with the base using conventional methods described above. It may be preferred to have the top of the container clear so that the cup cakes or other food articles may be seen.

While embodiments and applications of this invention have been shown and described, it would be apparent to those skilled in the art that many more modifications than mentioned above are possible without departing from the inventive concepts herein. It is to be understood that the present disclosure is illustrative only and that changes, variations, substitutions, modifications and equivalents will be readily apparent to one skilled in the art and that such may be made without departing from the spirit of the invention as defined by the following claims.

1. A cup cake tray comprising:
a tray base having one or more cup cake cavities configured to receive a cup cake;
one or more retainers coupled to the tray base around the edges of each cavity opening, each retainer having a portion forming cup cake engagement portions;
wherein, the cup cake engagement portions are configured to engage a top edge of the cup cake and hold the cup cake in the cavity, thereby preventing inadvertent cup cake movement out of the cavity.

2. The cup cake tray of claim 1, wherein the retainers are integral with the tray base.

3. The cup cake tray of claim 1, wherein the retainers are attached to the tray base in a secondary operation.

4. The cup cake tray of claim 1, wherein the tray base and retainers are formed by injection molding, blow molding, thermoforming or vacuum molding techniques.

5. The cup cake tray of claim 1, wherein the tray base and retainers are made from polystyrene or polyethylene, rubber, or any suitable material.

6. The cup cake tray of claim 1, further comprising finger slots formed in the tray base on opposite sides of the cavities, wherein the finger slots are sized and shaped for insertion of a pair of fingers on opposite sides of a cavity to engage and compress the cup cake to disengage the cup cake from the cup cake engagement portion for removal of the cup cake from the cavity.

7. The cup cake tray of claim 1, further comprising a top coupled to the tray base.

8. The cup cake tray of claim 7, wherein the top is coupled to the tray base by an integral hinge.

9. The cup cake tray of claim 7, wherein the top includes a locking feature with the base.

10. A cup cake tray comprising:
a tray base having one or more cup cake cavities configured to receive a cup cake;
one or more retainers coupled to the tray base around the edges of each cavity opening, each retainer having a portion forming cup cake engagement portions;
wherein, the cup cake engagement portions are configured to engage a top edge of a cup cake and hold the cup cake in the cavity, thereby preventing inadvertent cup cake movement out of the cavity; and
a tray top coupled to the tray base configured to cover the cup cakes without touching the cup cake or any cup cake icing.

11. The cup cake tray of claim 10, wherein the top is coupled to the tray base by an integral hinge.

12. The cup cake tray of claim 10, wherein the tray base, retainers and top are formed by injection molding, blow molding, thermoforming or vacuum molding techniques.

13. The cup cake tray of claim 10, wherein the tray base, retainers and top are made from polystyrene or polyethylene, rubber, or any suitable material.

14. The cup cake tray of claim 10, further comprising finger slots formed in the tray base on opposite sides of the cavities, wherein the finger slots are sized and shaped for insertion of a pair of fingers on opposite sides of a cavity to engage and compress the cup cake to disengage the cup cake from the cup cake engagement portion for removal of the cup cake from the cavity.

15. The cup cake tray of claim 10, further comprising a locking feature between the top and the base configured to keep the top in the closed position.

16. A method of using a cup cake tray comprising:
providing a cup cake tray having one or more cup cake cavities configured to receive a cup cake and one or more retainers coupled to the tray base around the edges of each cavity opening forming engagement portions configured to engage a top edge of a cup cake;
inserting one or more cup cakes into the one or more cup cake cavities; and
engaging a top of the cup cake with the cup cake engagement portions, thereby preventing inadvertent cup cake movement out of the cavity.

17. The method of claim 16, where the cup cake tray includes finger slots or grooves proximate the cavities, the method further comprising:
inserting fingers in the slots or grooves to engage the cup cake;
compressing the cup cake to disengage the cup cake from the engagement portions; and
removing the cup cake from the cavity.

18. The method of claim 16, where the cup cake tray includes a tray top, the method further comprising:
attaching the tray top to the tray base.
